(19) United States
(12) Patent Application Publication
(10) Pub. No.: US 2014/0350928 A1
(43) Pub. Date: Nov. 27, 2014

(54) Method For Finding Elements In A Webpage Suitable For Use In A Voice User Interface

(71) Applicant: Microsoft Corporation, Redmond, WA (US)

(72) Inventors: Andrew Stephen Zeigler, Seattle, WA (US); Michael H. Kim, Redmond, WA (US); Rodger Benson, Seattle, WA (US); Raman Sarin, Redmond, WA (US); Yun-Cheng Ju, Bellevue, WA (US)

(73) Assignee: Microsoft Corporation, Redmond, WA (US)

(21) Appl. No.: 13/899,056

(22) Filed: May 21, 2013

(51) Int. Cl. G10L 15/26

(52) U.S. Cl. CPC G10L 15/26
USPC 704/235

(57) ABSTRACT

A voice interface for web pages or other documents identifies interactive elements such as links, obtains one or more phrases of each interactive element, such as link text, title text and alternative text for images, and adds the phrases to a grammar which is used for speech recognition. A click event is generated for an interactive element having a phrase which is a best match for the voice command of a user. In one aspect, the phrases of currently-displayed elements of the document are used for speech recognition. In another aspect, phrases which are not displayed, such as title text and alternative text for images, are used in the grammar. In another aspect, updates to the document are detected and the grammar is updated accordingly so that the grammar is synchronized with the current state of the document.

### BACKGROUND

Web pages are examples of documents which are rendered by client computing devices such as laptops, personal computers, game consoles and smart phones. Web pages can be coded using HyperText Markup Language (HTML), for instance, and rendered by web browser code for display. Interactive elements in the document such as hyperlinks can be selected by a user to view additional content, such as by using a mouse or touching a touch screen to select the link. However, web pages are not commonly designed for voice interaction. Moreover, some solutions which do exist require the web page to be coded specially for voice interaction.

### SUMMARY

Technology described herein provides various embodiments for providing a voice user interface for interactive elements of a document.

In one approach, a document is analyzed to identify an interactive element in the document, e.g., a hyperlink or other link, button or input field. The interactive element is defined by associated code which comprises one or more phrases associated with the interactive element. For example, in an HTML document, tags are used to signal the presence of different types of interactive elements. The document is rendered, e.g., by a web browser, for display on a display device. A user then provides a voice command to select the interactive element. The voice command is converted to text and compared to the one or more phrases in a grammar of candidate phrases. Upon detecting a match, a click event is generated for the interactive element which is the closest match. That is, the interactive element is selected as if it were clicked on by a pointing device such as a mouse.

Further, the candidate elements include one or more phrases of the interactive element in response to determining that a representation of the interactive element is currently within a display region of the display device. As a result, the voice command need not be compared to phrases of interactive elements which are part of the document but not currently displayed. This increases the accuracy of the voice interface while reducing the computational load.

Further, the accuracy of the voice interface is improved by using various types of phrases which are associated with the interactive element. These can include phrases which are provided on the display such as link text, as well as phrases which are not provided on the display such as title text and alternative (alt) text.

Moreover, an update to an interactive element can be detected in which a new phrase replaces an initial phrase in the document. In this case, the new phrase replaces the initial phrase in a grammar of candidate phrases which are compared to a voice command.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In the drawings, like-numbered elements correspond to one another.

FIG. 1 depicts a computing system comprising a client computing device 145, a network communication medium 170 and a server 180.

FIG. 2A depicts an example embodiment of the client computing device 145 of FIG. 1.

FIG. 2B depicts an example process flow for components of the code 155 of FIG. 2A.

FIG. 3 depicts an example block diagram of the client computing device 145 of FIG. 1 in the form of a multimedia console 100 such as a gaming console.

FIG. 4 depicts another example block diagram of the client computing device 145 of FIG. 1 in the form of a computing system 200.

FIG. 5A depicts an overview of a process for providing a voice user interface to a document.

FIG. 5B provides example details of step 502 of FIG. 5A for analyzing a document to identify interactive elements and associated phrases.

FIG. 5C provides example details of step 504 of FIG. 5A for comparing a voice command to associated phrases of interactive elements.

FIG. 5D provides example details of step 524 of FIG. 5C for comparing a candidate phrase to a sequence of spoken words.

FIG. 5E provides example details of step 506 of FIG. 5A for performing a disambiguation process.

FIG. 5F provides example details of step 508 of FIG. 5A for detecting and processing updated interactive element.

FIG. 6A depicts a display of a top portion of a document in a display region of a display device.

FIG. 6B depicts a display of a bottom portion of the document of FIG. 6A in the display region of the display device.

FIG. 6C depicts the top portion of the document of FIG. 6A with disambiguation labels added to link text 610 and 612.

FIG. 6D depicts the top portion of the document of FIG. 6C with the addition of a changed appearance for the link text 610 and 612 and removal of link text 614 from FIG. 6C.

FIG. 7A1 depicts example code of the interactive element 640 of FIG. 6A.

FIG. 7A2 depicts an example grammar entry corresponding to FIG. 7A1.

FIG. 7B1 depicts example code of the interactive element 641 of FIG. 6A.

FIG. 7B2 depicts an example grammar entry corresponding to FIG. 7B1.

FIG. 7C1 depicts example code of the link 614 of the interactive element 642 of FIG. 6A.

FIG. 7C2 depicts example code of the image 616 of the interactive element 642 of FIG. 6A.

FIG. 7C3 depicts an example grammar entry corresponding to FIGS. 7C1 and 7C2.

FIG. 7D1 depicts example code of the interactive element 643 of FIG. 6A.

FIG. 7D2 depicts an example grammar entry corresponding to FIG. 7D 1.

FIG. 7E1 depicts example code of the interactive element 644 of FIG. 6A.

FIG. 7E2 depicts an example grammar entry corresponding to FIG. 7E1.

FIG. 7F1 depicts an example of an interactive element which is a button.

FIG. 7F2 depicts example code of the interactive element of FIG. 7F1.

FIG. 7F3 depicts an example grammar entry corresponding to FIG. 7F2.

FIG. 7G1 depicts an example of an interactive element which is an input of type submit.

FIG. 7G2 depicts example code of the interactive element of FIG. 7G1.

FIG. 7G3 depicts example grammar entries corresponding to FIG. 7G2.

FIG. 7H1 depicts an example of an interactive element which is an input of type checkbox.

FIG. 7H2 depicts example code of the interactive element of FIG. 7H1.

FIG. 7H3 depicts example grammar entries corresponding to FIG. 7H2.

FIG. 7I1 depicts an example of an interactive element which is an input of type radio.

FIG. 7I2 depicts example code of the interactive element of FIG. 7I1.

FIG. 7I3 depicts example grammar entries corresponding to FIG. 7I2.

FIG. 7J1 depicts an example of an interactive element which is a select option.

FIG. 7J2 depicts example code of the interactive element of FIG. 7J1.

FIG. 7J3 depicts example grammar entries corresponding to FIG. 7J2.

### DETAILED DESCRIPTION

The technology described herein provides a voice user interface to a document such as a web page. Natural user interfaces (NUI) have become popular in allowing users to interact with applications on computing devices such as web-enabled game consoles, televisions and other multimedia devices. A NUI allows the user to use a combination of voice commands and gestures. For example, gestures such as a hand wave or other bodily movement can be used to interact with an application to enter a command or play a game. A motion detection camera can be used to recognize the gestures. Similarly, a voice command can be matched to a command to invoke a function. For instance, a command can be used to make a menu selection (e.g., using phrases such as “play movies,” or “play games”). In the case of playing a movie, the user can speak commands such as “pause,” “fast forward” and “rewind.” The ability to browse the web using voice commands is particularly useful in scenarios in which a manual input device is not available or is inconvenient.

Generally, a voice interface can include a set of phrases that a user can speak, a set of actions that are bound to those phrases and a user experience that lets the user know what phrases they can speak. The voice interface presents the result of the actions performed by the speaking of the phrase. The user experience may present the results, e.g., using another human voice, a video display, a refreshable braille display, or any device that can be used to convey information to the user.

The set of phrases which are to be recognized and the corresponding actions in these situations may be relatively limited and are generally predetermined. In contrast, in providing a voice user interface for a document such as a webpage, the set of phrases which are to be recognized and the corresponding actions are not generally predetermined. Commonly, webpages comprise code in the form of HTML (markup), JAVASCRIPT (program code), and Cascading Style Sheets or CSS (styling). Although there is some work from the W3C in the form of standards and non-standards track specifications for adding voice interfaces to webpages, there is no broadly-deployed solution. As a result, web pages today are not designed for voice interaction.

Techniques provided herein enable the automatic construction and execution of a voice interface for web pages. This allows a user to easily browse the web without a manual input device such as a controller, remote, mouse, phone, or tablet. Given a web page, a voice user interface can be created by processing the HTML, CSS, and JAVASCRIPT code which defines interactive elements of the web page. The code includes phrases which can be used to build a grammar or dictionary of candidate phrases for voice recognition. The grammar allows the user to speak phrases that are consistent with phrases visible on the page (or not visible, in some cases) in order to navigate a web site or other source of data.

Moreover, the techniques automatically determine the components of a web page that are suitable for building a voice interface. For example, hypertext links, which usually contain text and a link, are useful for building a voice interface. However, text that is not associated with an interactive element and has no action tied to it is generally not a useful component of a voice interface. In addition to building a grammar, the techniques can include intelligent filtering of the grammar so that matching to a voice command is limited to phrases associated with interactive elements in a currently displayed portion of a page. The techniques also include use of phrases associated with code of the interactive elements but not rendered on a display, and synchronizing of the grammar with updates to individual interactive elements.

The techniques also include a disambiguation process which allows a user to select from among a group of interactive elements which have highest matching scores relative to a voice command.

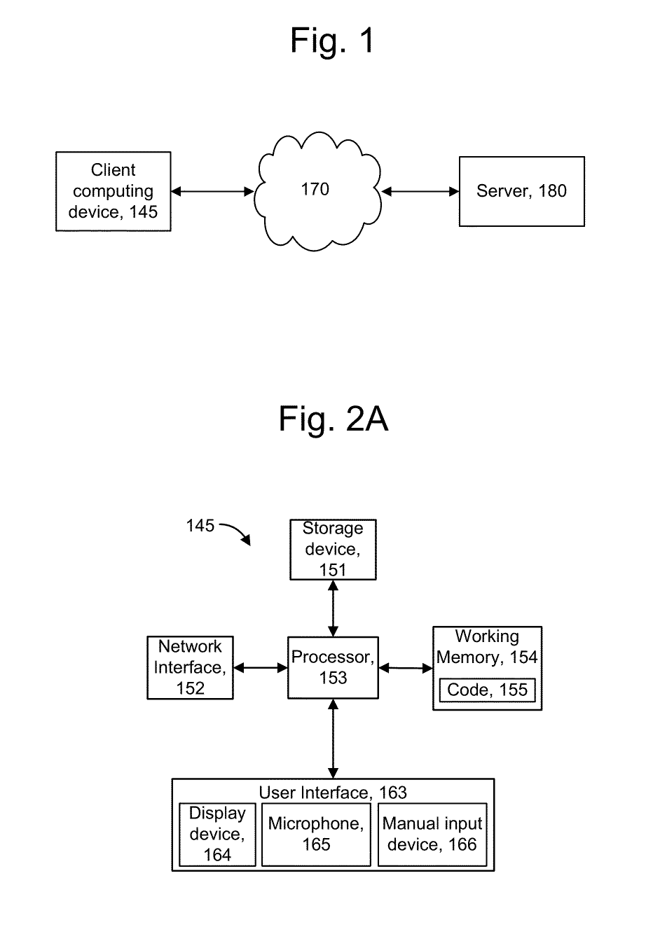

FIG. 1 depicts a computing system comprising a client computing device 145, a network communication medium 170 and a server 180. The client computing device can be, e.g., a laptop, personal computer, game console, smart phone, wearable computing device or web-enabled television. The server represents a computing device which hosts documents such as web pages. The network communication medium allows the client computing device to communicate with the server. In one scenario, the client computing device runs web browser code which provides a web browser application. When the web browser is launched, it loads document code of a home page document. Subsequently, the user can select an interactive element of the document to perform an action. For example, the action can be to load another web page from a server via the network. In another example, the action is performed locally at the client computing device such as by executing JAVASCRIPT code of the document code at the client computing device. The action can result in an update to the display of the document, for instance, by displaying a different section of the document or altering the document's content.

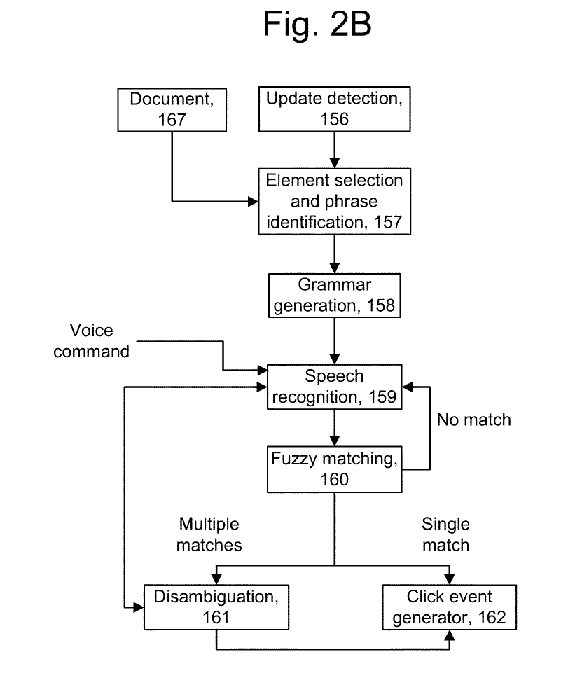

FIG. 2A depicts an example embodiment of the client computing device 145 of FIG. 1. The computing device includes a storage device 151 such as a hard disk, solid state drive or portable media. These are types of memories which are non-volatile. A network interface 152 such as a network interface card allows the computing device to communicate via the network communication medium 170. A processor 153 executes code in a working memory 154. The working memory may be a volatile type such as RAM which stores code 155 that is loaded from the storage device 151 for use by the processor. Further details of the code are provided in FIG. 2B.

A user interface 163 includes a display device 164, e.g., a screen, a microphone 165 which receives spoken user commands and provides them to the speech recognition code and an optional manual input device 166 such as a mouse or keyboard.

The storage device and working memory are examples of tangible, non-transitory computer- or processor-readable storage devices. Storage devices include volatile and nonvolatile, removable and non-removable devices implemented in any method or technology for storage of information such as computer readable instructions, data structures, program modules or other data. Computer storage devices include RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other device which can be used to store the desired information and which can accessed by a computer.

FIG. 2B depicts an example process flow for components of the code 155 of FIG. 2A. A document 167 can be provided by document code such as in a web page (e.g., HTML, CSS and/or JAVASCRIPT code). The document is provided to element selection and phrase identification code 157 when the web page is loaded. Interactive elements which are suitable for a voice user interface are selected and phrases associated with the interactive elements are identified. The identity of the interactive elements and the associated phrases are provided to a grammar generation code 158. Executable code (click event code) of the interactive element can also be identified and provided to the grammar generation code. The executable code is executed when the interactive element is selected by generating a click event for it. For example, this code could be a link which points to a page to load when the element is selected. The grammar can include an entry for each interactive element linked to one or more associated phrases. In one approach, the grammar generation is a statistical language model (SLM) grammar which is trained using the phrases associated with the interactive elements. Another approach uses a phrase grammar model.

Specifically, the SLM grammar can be trained with the phrases in the web page. In one approach, each phrase is linked to an interactive element in a pair. Multiple phrases can be linked to the same interactive element. A set of the pairs is therefore provided to the SLM grammar. Further, the phrases can be parsed into n-gram sub-phrases for use as additional training phrases. Moreover, the SLM grammar can be updated as the page changes. Matching and scoring of potential recognitions can be based on the number of words matched in a phrase, the word order and confidence levels associated with each word and phrase.

Update detection code 156 detects updates to the document and can modify the grammar. For example, a phrase which is no longer associated with an interactive element can be removed from the entry for that interactive element.

Speech recognition code 159 receives a voice command, converts it to a phrase and compares it to the phrases in the grammar to identify a match. Matching phrases and confidences are provided to fuzzy matching code 160. The fuzzy matching code determines if there is no good match, a single good match or multiple good matches. If there is no good match, the user may be prompted to repeat the voice command for processing by the speech recognition code. If there is a single good match, a click event generator 162 generates a click event for the interactive element. The click event selects an interactive element as if the interactive element had been clicked on by a pointing device. If there are multiple good matches, disambiguation code 161 can invoked in which a disambiguation user interface code modifies the display of the document such as by adding labels which identify and rank the interactive elements which are the multiple good matches. The user may be prompted to select one of the labels by a voice command which is processed by the speech recognition code. Subsequently, the click event generator generates a click event for the selected interactive element.

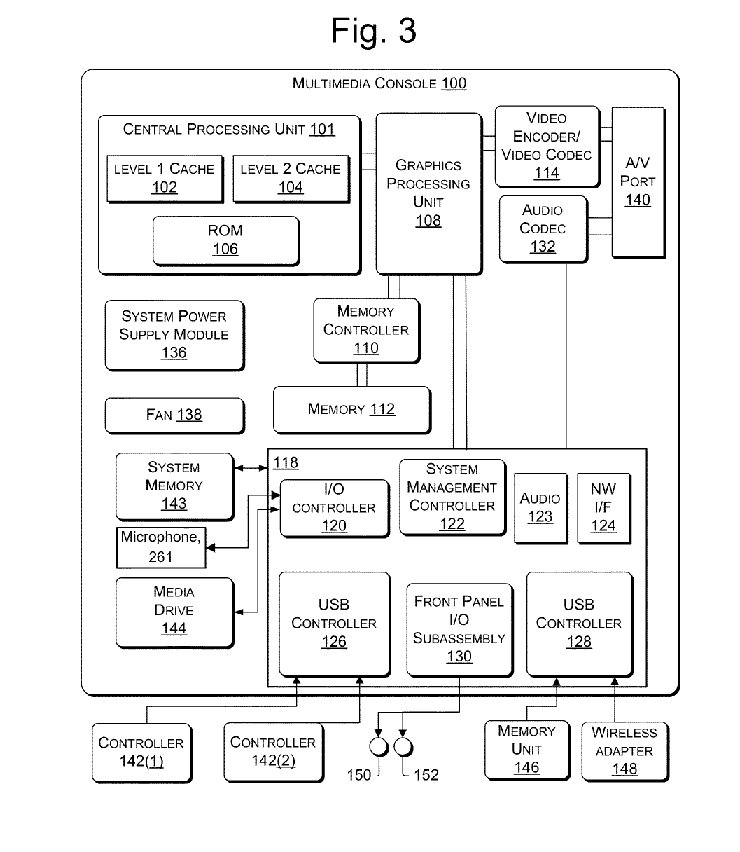

FIG. 3 depicts an example block diagram of the client computing device 145 of FIG. 1 in the form of a multimedia console 100 such as a gaming console. The multimedia console has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The memory 106 such as flash ROM may store executable code that is loaded during an initial phase of a boot process when the multimedia console is powered on.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as RAM (Random Access Memory).

The multimedia console includes an I/O controller 120, a system management controller 122, an audio processing unit 123, a network interface 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface (NW IF) 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive. The media drive 144 may be internal or external to the multimedia console. Application data may be accessed via the media drive 144 for execution, playback, etc. by the multimedia console. The media drive 144 is connected to the I/O controller 120 via a bus, such as a Serial ATA bus or other high speed connection. A microphone 261 for receiving a voice input can also be provided.

The system management controller 122 provides a variety of service functions related to assuring availability of the multimedia console. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console. A system power supply module 136 provides power to the components of the multimedia console. A fan 138 cools the circuitry within the multimedia console.

The CPU 101, GPU 108, memory controller 110, and various other components within the multimedia console are interconnected via one or more buses, including serial and parallel buses, a memory bus, a peripheral bus, and a processor or local bus using any of a variety of bus architectures.

When the multimedia console is powered on, application data may be loaded from the system memory 143 into memory 112 and/or caches 102, 104 and executed on the CPU 101. The application may present a graphical user interface that provides a consistent user experience when navigating to different media types available on the multimedia console. In operation, applications and/or other media contained within the media drive 144 may be launched or played from the media drive 144 to provide additional functionalities to the multimedia console.

The multimedia console may be operated as a standalone system by simply connecting the system to a television or other display. In this standalone mode, the multimedia console allows one or more users to interact with the system, watch movies, or listen to music. However, with the integration of broadband connectivity made available through the network interface 124 or the wireless adapter 148, the multimedia console may further be operated as a participant in a larger network community.

When the multimedia console is powered on, a specified amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The console 100 may receive additional inputs from a depth camera system.

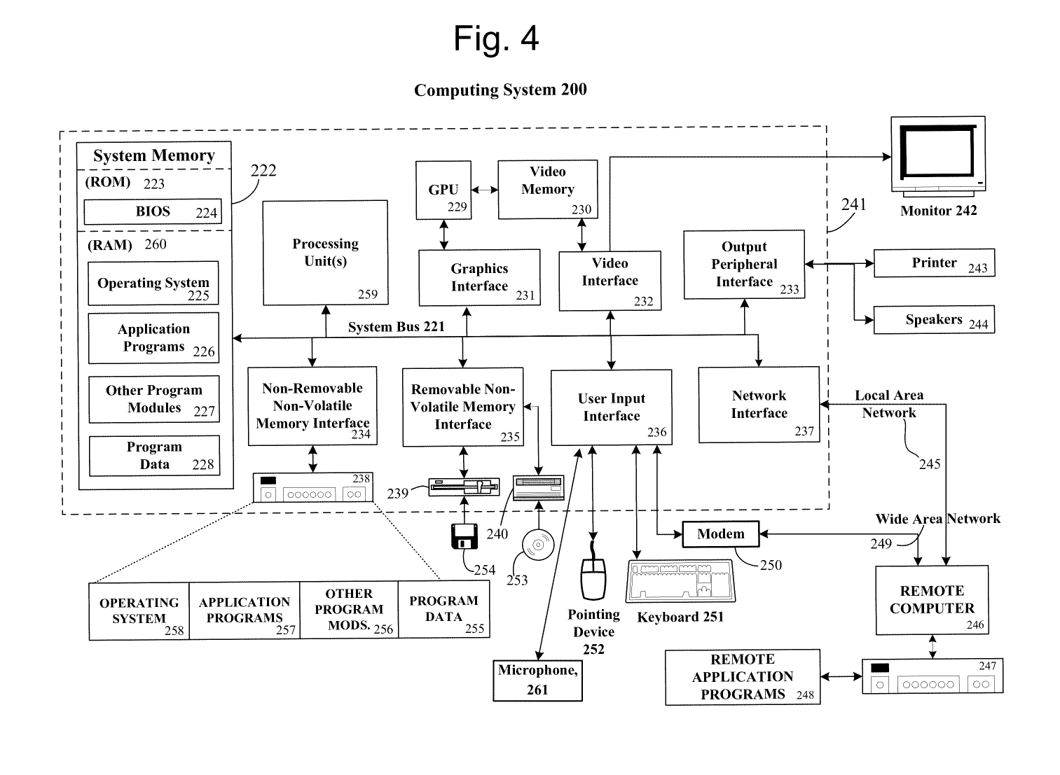

FIG. 4 depicts another example block diagram of the client computing device 145 of FIG. 1 in the form of a computing system 200. In an interactive system, the computing system can be used to interpret one or more gestures or other movements and, in response, update a visual space on a display. The computing system comprises a computer 241, which typically includes a variety of tangible computer-readable storage media. This can be any available media that can be accessed by computer and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer, such as during start-up, is typically stored in ROM 223. RAM 260 typically contains data and/or program modules that are immediately accessible to and/or presently being operated on by processing unit 259. A graphics interface 231 communicates with a GPU 229. Operating system 225, application programs 226, other program modules 227, and program data 228 are also provided.

The computer may also include other removable/non-removable, volatile/nonvolatile computer storage media, e.g., a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile tangible computer-readable storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media provide storage of computer-readable instructions, data structures, program modules and other data for the computer. For example, hard disk drive 238 is depicted as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to depict that, at a minimum, they are different copies. A user may enter commands and information into the computer through input devices such as a keyboard 251 and pointing device 252, commonly referred to as a mouse, trackball or touch pad. Other input devices may include a microphone 261, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer, although only a memory storage device 247 has been depicted. The logical connections include a local area network (LAN) 245 and a wide area network (WAN) 249, but may also include other networks. Such networking environments are commonplace in offices, enterprise-wide computer networks, intranets and the Internet.

When used in a LAN networking environment, the computer is connected to the LAN 245 through a network interface or adapter 237. When used in a WAN networking environment, the computer typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer, or portions thereof, may be stored in the remote memory storage device. Remote application programs 248 reside on memory device 247. It will be appreciated that the network connections shown are exemplary and other means of establishing a communications link between the computers may be used.

The computing system can include a tangible computer-readable storage device or apparatus having computer-readable software embodied thereon for programming at least one processor to perform methods as described herein. The tangible computer-readable storage device can include, e.g., one or more of components 222, 234, 235, 230, 253 and 254. Further, one or more processors of the computing system can provide processor-implemented methods as described herein. The GPU 229 and the processing unit 259 are examples of processors.

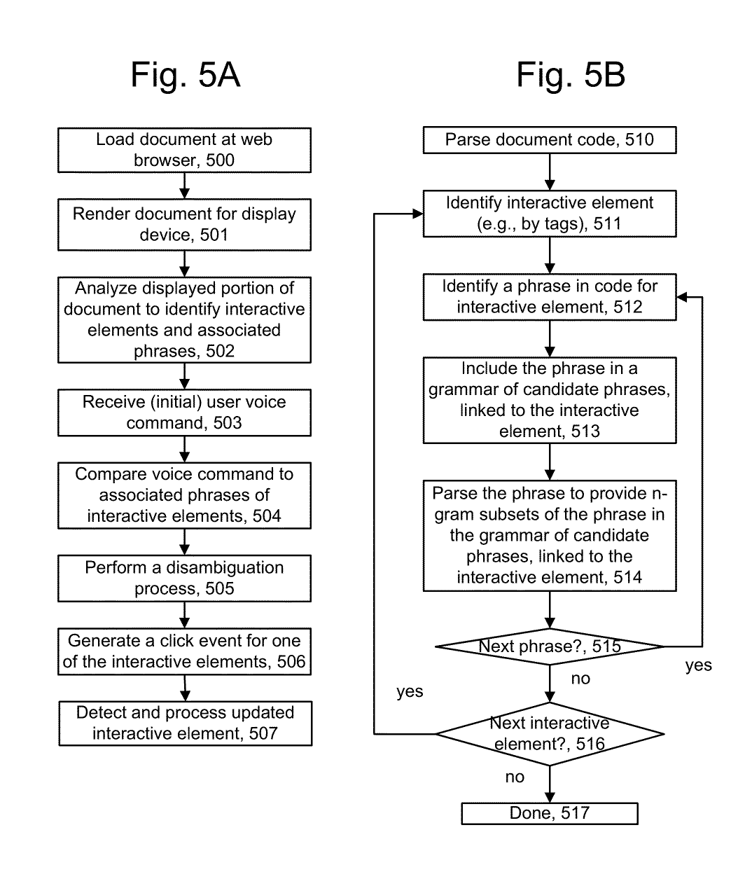

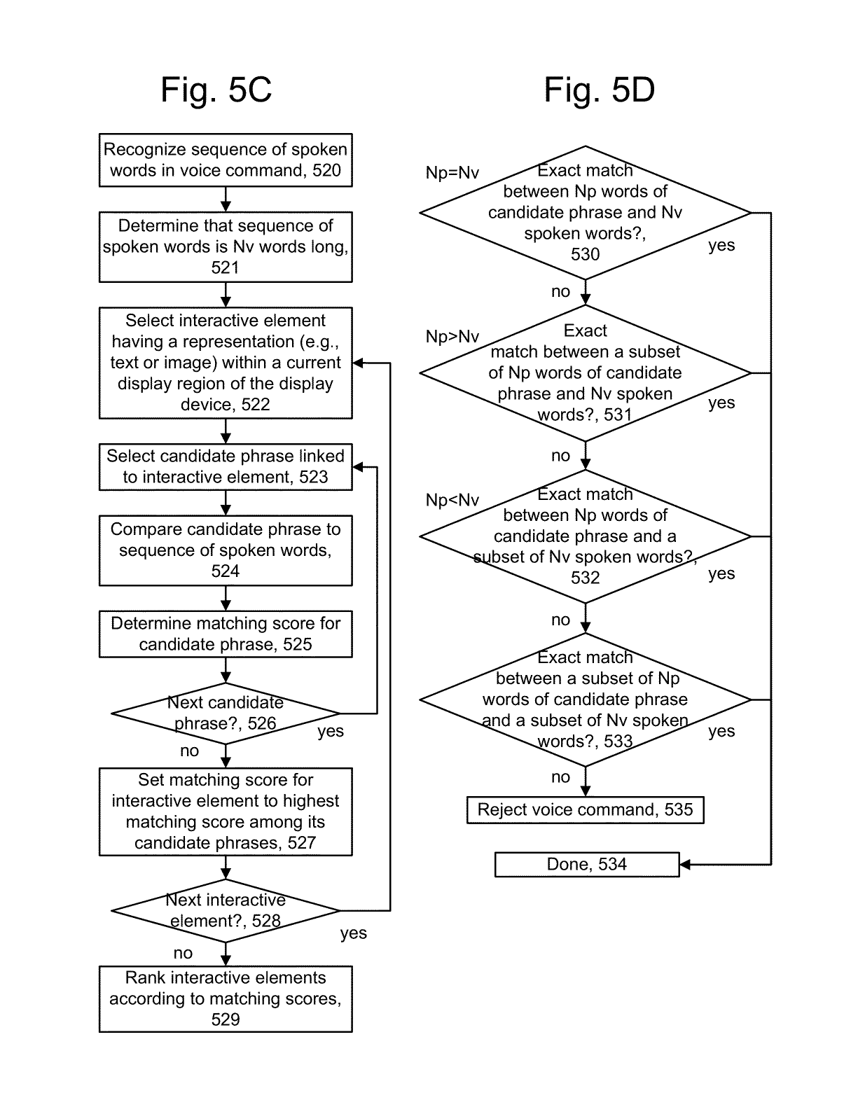

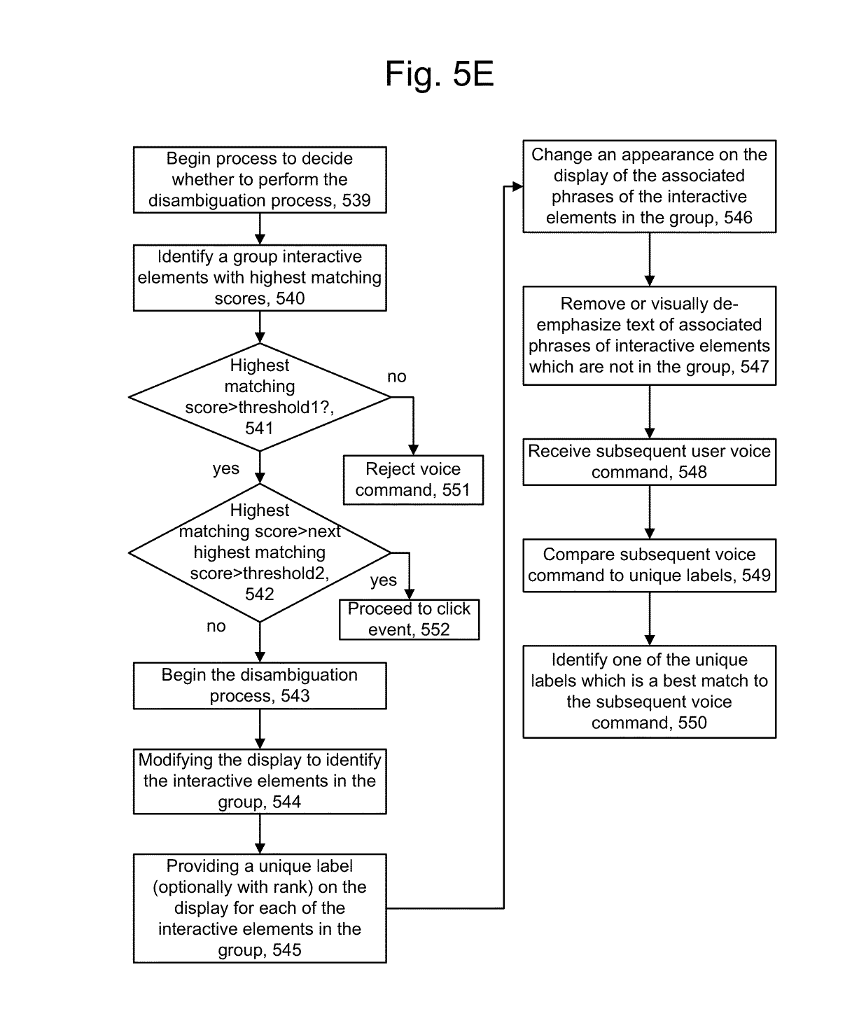

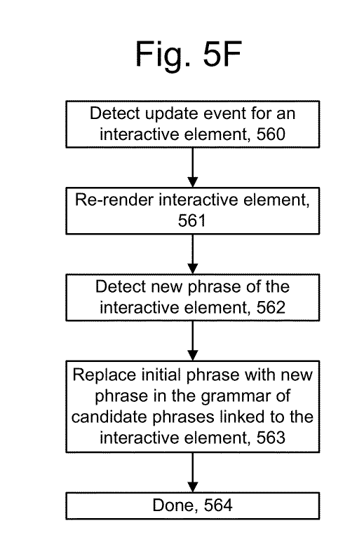

FIG. 5A depicts an overview of a process for providing a voice user interface to a document. The process includes the steps of: load document at web browser, 500; render document for display device, 501; analyze displayed portion of document to identify interactive elements and associated phrases, 502 (see FIG. 5B for further details); receive (initial) user voice command, 503; compare voice command to associated phrases of interactive elements, 504 (see FIG. 5C for further details); perform an optional disambiguation process, 505 (see FIG. 5E for further details); generate a click event for one of the interactive elements, 506 (e.g., using the click event generator code 162 of FIG. 2A); and detect and process updated interactive element, 507 (see FIG. 5F for further details). The document can be a web page, a list of bookmarks, or other document.

The steps can be performed at a client computing device in one approach. An alternative approach is to analyze the document and obtain a grammar of phrases at a server, then provide the grammar to the client computing device with the requested document. Another alternative approach is to maintain the grammar at the server, communicate the voice command from the client computing device to the server, perform voice to phrase conversion at the server, compare the spoken phrase to the extracted grammar of the document to identify an interactive element in the document which is a best match and inform the client computing device of the best match. Another alternative approach is similar to the above but performs the voice to phrase conversion at the client computing device and communicates the spoken phrase to the server. The server then compares the spoken phrase to the grammar. Moreover, the steps shown are not necessarily performed as discrete steps or in the order shown. For example, the detecting and processing of an updated interactive element can occur at any time in the process. Further details regarding each of the steps are provided herein.

FIG. 5B provides example details of step 502 of FIG. 5A for analyzing a document to identify interactive elements and associated phrases. The process can be performed by the element selection and phrase identification code 157 of FIG. 2B, for instance. Set 510 includes parsing document code. For example, this can include analyzing HTML source code of the document. Another approach is to prepare a tree data structure which represents the document. For example, the Document Object Model (DOM) of the World Wide Web Consortium (W3C) provides a convention for representing and interacting with objects in HTML, Extensible HyperText Markup Language (XHTML) and Extensible Markup Language (XML) documents. The DOM provides a tree data structure. Objects in the DOM tree may be addressed and manipulated by using methods on the objects.

Step 511 include identifying an interactive element of the document. In an initial pass of the process, this can involve identifying a first interactive element in the document from tags in the document. For instance, specific tags which signal the presence of an interactive element can be detected. For example, an anchor tag is denoted by “<a>” in HTML code and denotes a hyperlink, the “<button>” tag defines a click button, the “<input>” tag defines an input control and the “<option>” tag defines an option in a drop-down list. The identifying of the interactive elements of the document can be limited to the interactive elements which are currently displayed.

In a specific implementation, the interactive elements can be expressed by the following function: VoicelnterfaceElements=findInterfaceElements(Document), where the Document is an HTML Document and its corresponding DOM (Document Object Model) can contain zero or more sub-Documents. VoicelnterfaceElements is a set of tuples (DOMElement*, Phrases) that relate a primary DOM element with text phrases. A DOMElement is an element in the HTML document that will be the target of the voice interaction. The DOMElement can be a “click” event, which is normally generated by a pointing device such as a mouse. “Phrases” is a list of zero or more phrases that, when spoken, should cause this element to be invoked.

The function works by performing a search of the DOM for any elements that have certain characteristics, as described below. One example type of interactive element is an anchor defined by anchor tags “(<a></a>).” Anchor links, denoted by the format “<a href=“foo”></a>” make up the vast majority of links on webpages. These are understood by every web browser, and do a good job of expressing semantic meaning to assistive technologies such as screen readers. Anchor tags usually contain text. However, in some cases they may just contain images. If the anchor contains text, the anchor text will be used. For instance in the code “<a> this is a link</a>,” the anchor text (link text) is “this is a link.” If the anchor contains an image and no displayed text, but contains alt (alternative) text, the alt text can be used for matching to the voice command. An example is: “<a><img src=”bat.png” alt=“A baseball bat”></a>, where “A baseball bat” is the alt text and bat.png is an image file. If the anchor does not have any usable text (e.g., no child text node under the anchor, and no child nodes with an alt attribute), then the link can be added without text and made accessible to the user via a command such as “show unnamed links.”

Another example interactive element is a button defined by the tags: (<button></button>) in which case the text node inside the <button> tag can be used for matching to the voice command. Another example interactive element is an input of type=submit defined by the tags: “<input type=”submit“></input>.” The text under the “value” attribute can be used for matching to the voice command in this example code: <input type=“submit” value=“click me”></input>. These elements could also be accessed by a “show unnamed type” command.

Other example interactive elements that may be identified in the code of a document are DOM elements that have a click event handler. For example, a DOM element that has a JAVASCRIPT click, double click or mouse down event may have the same semantic meaning as a link. For example, a page might have a <div> element that handles the click event, and then navigates the browser to a different URL. The <div> tag defines a division or a section in an HTML document. In this case, a search can be made of the text nodes under the element with the registered event handler.

Another example interactive element is a select option or drop down defined by: “<option>” in which case the text contained in each option tag can be used for matching to the voice command.

Step 512 identifies a phrase in code for the interactive element. For example, this can be to identify a first phrase for the interactive element. As discussed, the phrase can be link text (also known as a link label), title text, input text or alternative image text in an HTML document, for instance. It is also possible for a phrase to be provided indicating the type of the interactive element (e.g., link, button, checkbox).

Another option is to check for an HTML <label> element which has an “htmlFor” attribute containing the ID (identifier) for another element on the page which is assumed to be an interactive element. If it is determined that the htmlFor attribute is valid, the text between <label> and </label> can include a phrase which can be added to the grammar to activate the interactive element pointed to by htmlFor. This approach is useful, e.g., for checkboxes and radio buttons.

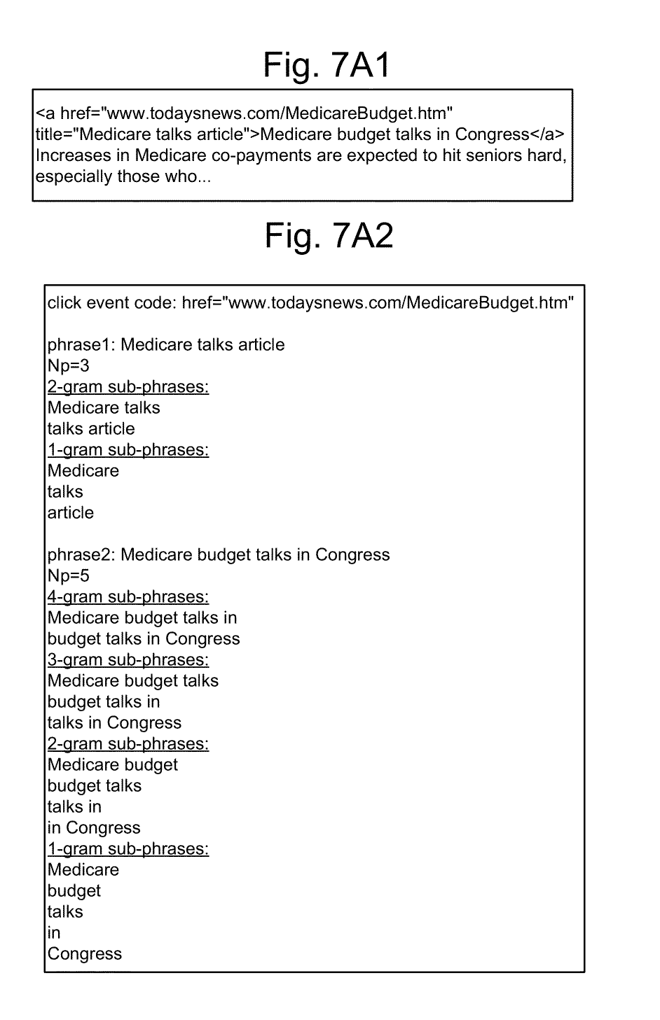

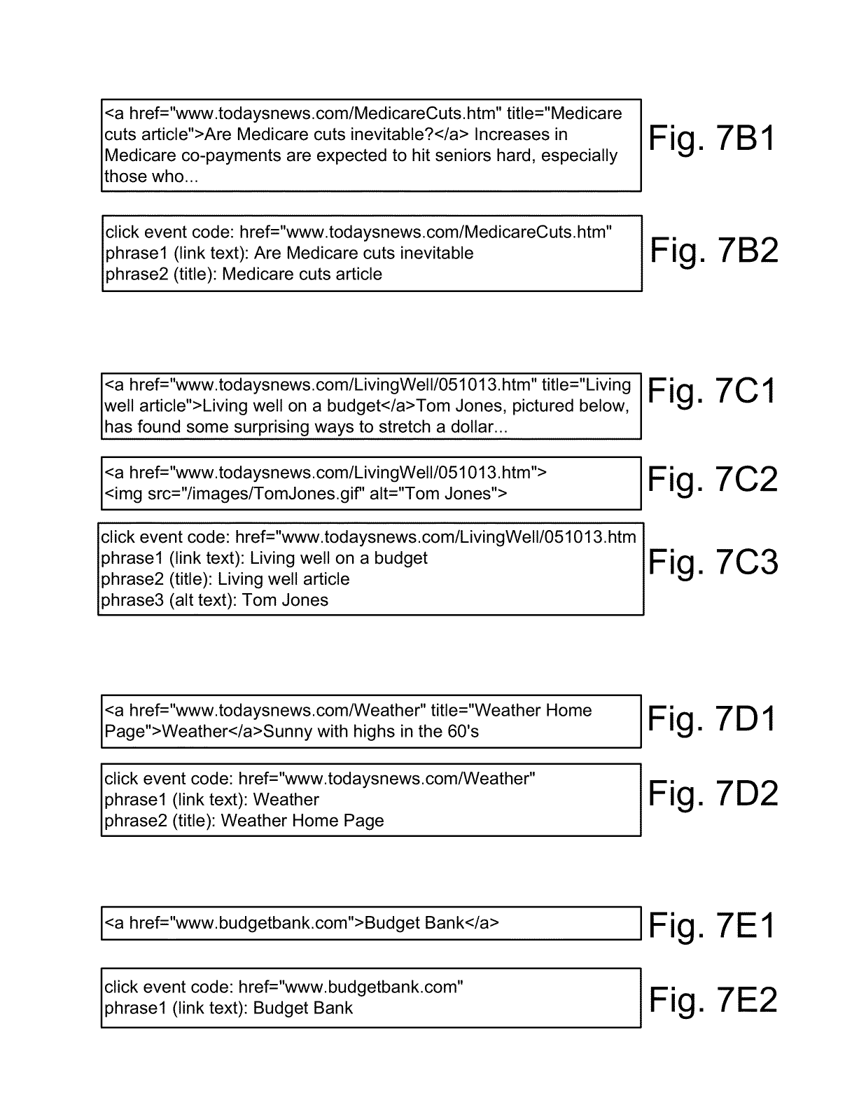

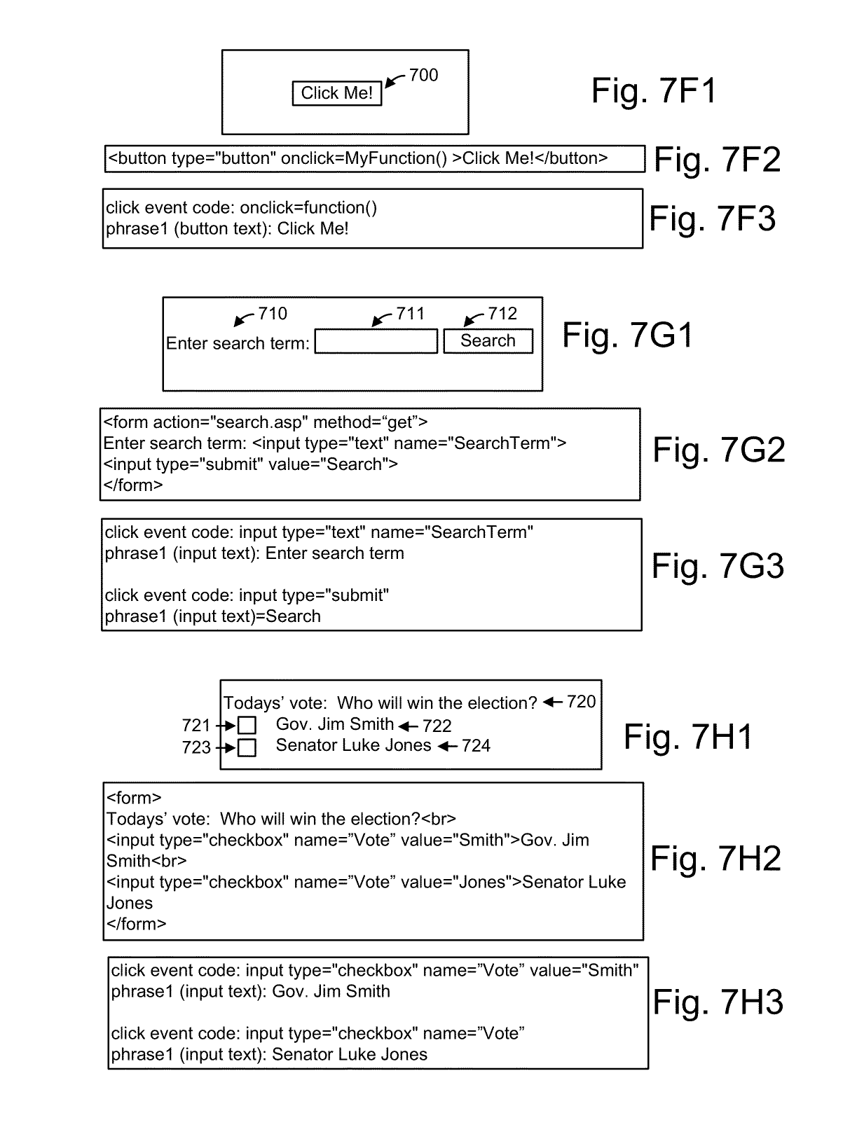

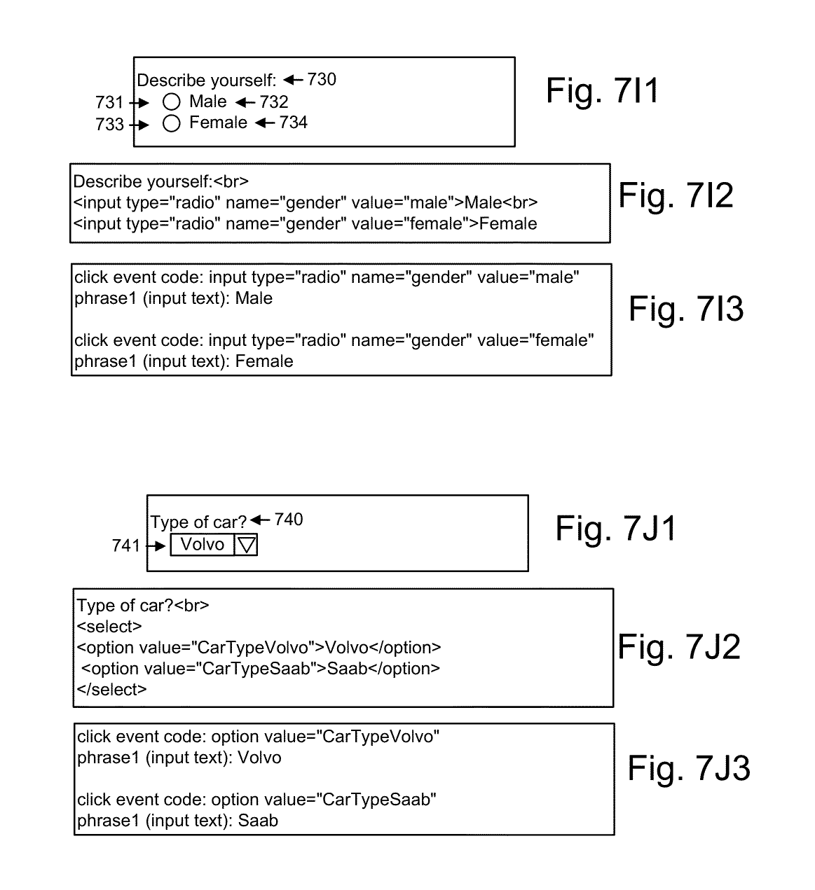

Step 513 involves including (adding) the phrase, linked to the interactive element, in a grammar of candidate phrases. The grammar can be provided by the grammar generation code 158 of FIG. 2B, for instance. See, e.g., FIGS. 7A1-7J3 for further details. Step 514 involves parsing the phrase to provide n-gram subsets of the phrase, linked to the interactive element, in the grammar of candidate phrases. For example, for a phrase which is a sequence of five words, there are 4-gram, 3-gram, 2-gram and 1-gram subsets of the phrase. See, e.g., FIGS. 7A1 and 7A2 for further details. Generally, a phrase represents a sequence of one or more words and has length of Np words, where Np is an integer number of one or more.

At decision step 515, if there is a next phrase to analyze for the current interactive element, steps 512-514 are repeated. If there is no next phrase to analyze for the current interactive element, decision step 516 determines if there is a next interactive element to analyze in the document. If decision step 516 is evaluated as “yes,” steps 511-514 are repeated for the next interactive element. If decision step 516 is evaluated as “no,” the process is done at step 517.

FIG. 5C provides example details of step 504 of FIG. 5A for comparing a voice command to associated phrases of interactive elements. Step 520 recognizes a sequence of spoken words in a voice command. The sequence can be an ordered sequence of one or more words and represents a phrase. Various technologies exist for conversion between a voice command and a phrase. This can be performed by the speech recognition code 159 of FIG. 2B, for instance.

Step 521 determines that the sequence of spoken words is Nv words long, where Nv is an integer of one or more. Step 522 selects an interactive element having a representation (e.g., text or image) within a current display region of the display device. For example, this can be the first interactive element in the document which is within the current display region. When a document is rendered for display on a display device, the rendering code knows the rendered size of the document, e.g., as measured by a rectangle which is a specified number of horizontal pixels in width and a specific number of vertical pixels in heights. The pixel size of the display is also known. If the rendered size is larger than the size of the display, scroll bars are inserted which allow the user to scroll the image to see different portions of the document. Commonly, vertical scrolling is used. The rendering code can be configured to note which interactive elements are currently being displayed and/or which interactive elements are not currently being displayed.

Step 523 selects a candidate phrase which is linked to the linked to interactive element. There can be one or more phrases linked to an interactive element. Step 524 compares the candidate phrase to the sequence of spoken words. This can be provided by the speech recognition code 159 of FIG. 2B, for instance. See, e.g., FIG. 5D for further details. Step 525 determines a matching score for the candidate phrase. The score indicates a degree to which the candidate phrase matches the sequence of spoken words. In one approach, a score is based on each word which is matched and each word which is not matched. In one approach, the matching scores can be based on a number of words in the phrase which match the sequence of spoken words. Relatively more matching words can result in a relatively higher score. In one approach, the matching scores are based on different levels of importance of the words in the sequence of spoken words.

Matching to relatively more important words can result in a relatively higher score. For example, in link text, the initial words (e.g., first, second) may be more important. As another example, words which are classified as articles in the English language such as “the,” “a” and “an” may be less important. A relative importance can be assigned to a word or phrase based on an appearance trait of the word or phrase. For example, a word or phrase which is rendered with a relatively larger font or a bold, underlined or italic font, could be more important than a word or phrase which is rendered with a relatively smaller font, or a non-bold, non-underlined or non-italic font. A relative importance can also be assigned to a word or phrase based on a relative importance of a heading tag. For example, a document may include phrases which are tagged with different levels of heading tags <h1> to <h6>, where <h1> defines the most important heading and <h6> defines the least important heading. A relative importance can be assigned to a word or phrase based on a position of the word or phrase in the document. For example, a position closer to the top of the document can be assigned a higher importance than a position closer to the bottom of the document. This process assumes that the user is relatively more likely to select an interactive element with a more prominent appearance.

A relative importance can be assigned to a word or phrase based on other meta data as well. The matching scores can thus be based on different levels of importance of different phrases of a plurality of phrases.

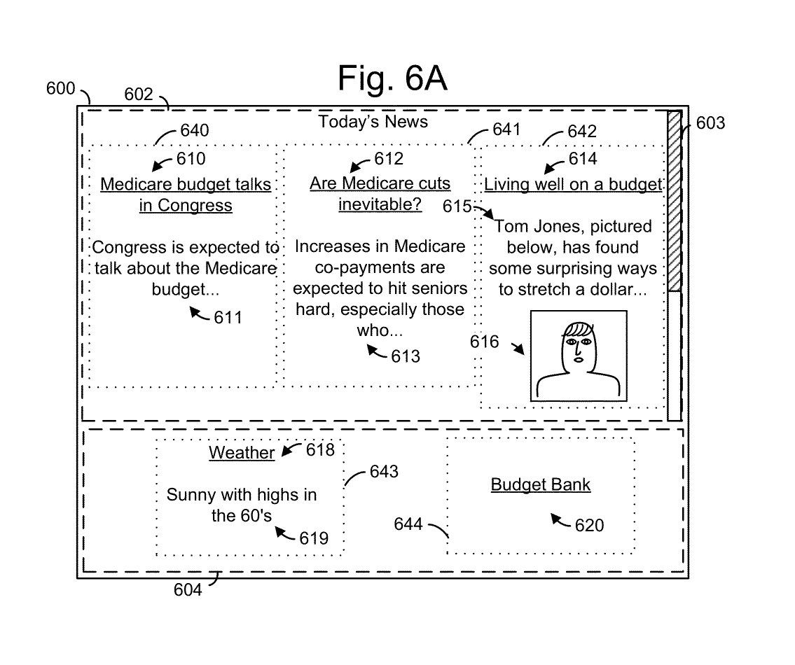

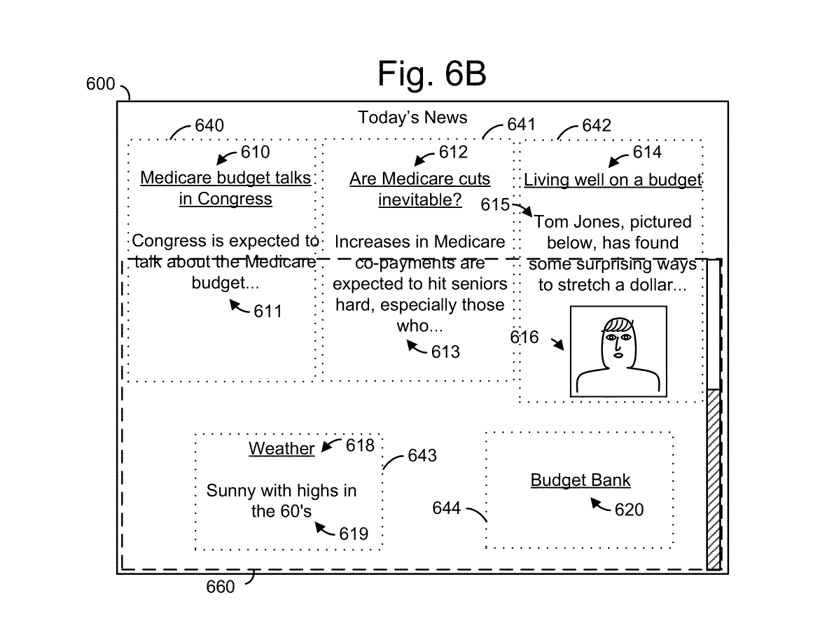

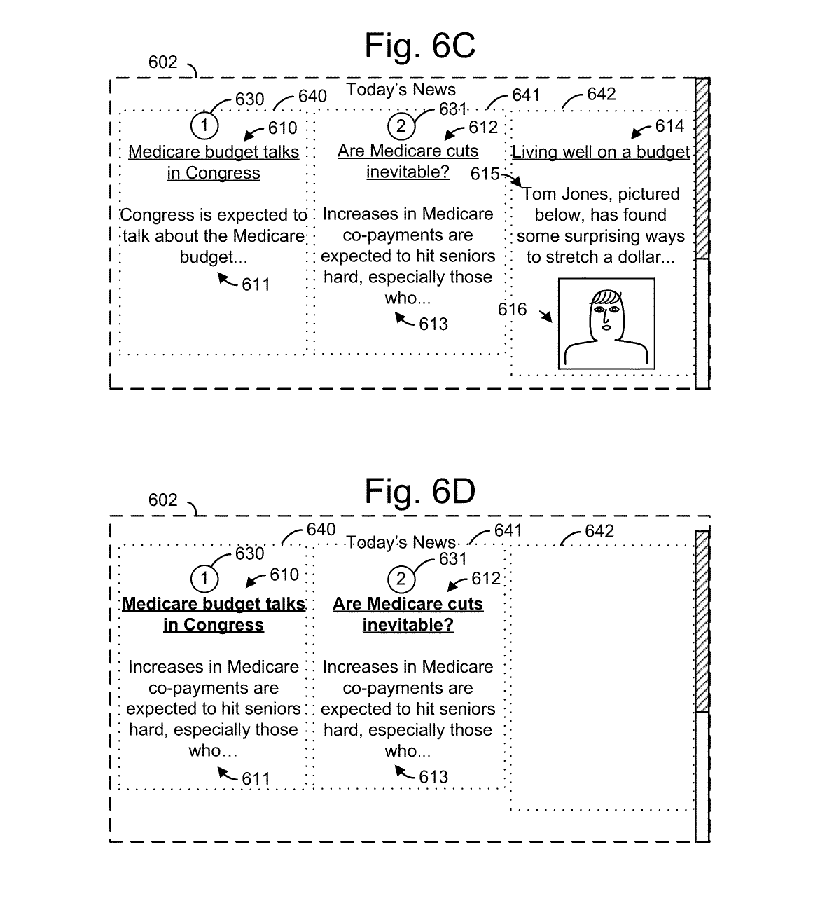

In one approach, a small penalty in the score is imposed when the voice command includes extra words that do not match a phrase. A larger penalty could be imposed if the voice command did not include all of the words in a phrase. Further, the process could adapt to the particular user. For example, a user may tend to add extra words before and/or after the link text. For instance, the user may add extra words before the link text such as “I select the” (e.g., “I select the Medicare article” for the link text 610 of FIG. 6A) or the user may add extra words after the link text such as “link” or “article” (e.g., “Medicare article” for the link text 610). Once this is learned, the superfluous words can be ignored and not affect the matching score.

A degree of confidence in the matching of each word can also be considered in the score. Decision step 526 determines if there is a next candidate phrase linked to the current interactive element to compare to the sequence of spoken words. If decision step 526 is evaluated as “yes,” steps 523-525 are repeated for a next candidate phrase. If decision step 526 is evaluated as “no,” step 527 sets a matching score for the interactive element to the highest matching score among its candidate phrases, in one approach.

Decision step 528 determines if there is a next interactive element to analyze in the document which is within the current display region. If decision step 528 is evaluated as “yes,” steps 522-527 are repeated for a next interactive element. If decision step 528 is evaluated as “no,” step 529 ranks the interactive elements according to their matching scores, e.g., highest score first.

FIG. 5D provides example details of step 524 of FIG. 5C for comparing a candidate phrase to a sequence of spoken words. A confidence level can indicate a degree of matching between each spoken word and each word of a phrase in the document. In some cases, a match can be declared between the two words if the confidence level exceeds a threshold confidence level. The threshold confidence level can be a predetermined level or a relative level. Further, a confidence level can indicate a degree of matching between a set of one or more spoken words and a set of one or more words of a phrase in the document. For example, the overall confidence level for a match of a candidate phrase to a spoken phrase can be based on the confidence levels of the matches to the constituent words of the phrases.

Decision step 530 addresses the case where Np (the number of words in a candidate phrase from the document)=Nv (the number of spoken words in a voice command). The decision step determines if there is an exact match between the set of Np words of the candidate phrase and the set of Nv spoken words. An exact match may occur when the confidence level of the match exceeds a threshold. If this decision step is evaluated to “yes,” the process is done at step 534.

If this decision step is evaluated to “no,” decision step 531 addresses the case where Np>Nv. The decision step determines if there is an exact match between a subset of the Np words of the candidate phrase and the set of Nv spoken words. With Np>Nv, there will be Np−Nn+1 subsets (strict subsets) of the Np words of the phrase to compare to the Nv spoken words. If this decision step is evaluated to “yes,” the process is done at step 534.

If this decision step is evaluated to “no,” decision step 532 addresses the case where Np<Nv. The decision step determines if there is an exact match between the set of Np words of the candidate phrase and a subset of the Nv spoken words. With Np<Nv, there will be Nv−Np+1 subsets (strict subsets) of the Nv spoken words to compare to the Np words of the phrase. If this decision step is evaluated to “yes,” the process is done at step 534.

If this decision step is evaluated to “no,” decision step 533 addresses the case where there was no match for the full set of spoken words or the full set of words of a phrase. The decision step determines if there is an exact match between any subset of one or more words of the Np words of the candidate phrase and any subset of one or more words of the Nv spoken words. If this decision step is evaluated to “yes,” the process is done at step 534. If this decision step is evaluated to “no,” the voice command is rejected at step 535 and the user may be asked to repeat the voice command.

The process can thus involve comparing a voice command of a user to a plurality of phrases, where the plurality of phrases comprise the link text of a plurality of links, and the comparing comprises comparing the sequence of words to the voice command and determining a longest subset of the sequence of words which matches the voice command. Based on the comparing, the process determines a matching score for each link indicating a degree of matching of its associated link text to the voice command. The matching score for at least one of the links is based on a number of words in the longest subset of the sequence of words which matches the voice command. The process identifies one of the links as a closest match to the voice command based on its matching score.

FIG. 5E provides example details of step 506 of FIG. 5A for performing a disambiguation process. A disambiguation process is a process which removes ambiguity when there are multiple viable matches of interactive elements to a voice command. It is possible for a web page to contain links that are duplicated many times on the page, yet are still a critical part of the user experience. For example, a news web page might have several news article abstracts, along with a link that reads, “Read More.” that will navigate to the full article. Additionally, some VUI (voice user interface) implementations allow the user to speak part of a phrase (instead of the full phrase) as a convenience. In this case, the user might say an ambiguous sub-phrase that appears in multiple phrases, and the user agent should determine the element that the user meant to invoke. If a user speaks a phrase that is ambiguous, the user agent (the browser) should determine which interface element to invoke. One solution is to provide a unique label for each of the ambiguous elements that the user can select by voice command to invoke the desired interactive element.

In one approach, on screen labels are provided proximate to on screen text or image representations of the interactive elements which are the multiple viable matches. Step 539 begins a process to decide whether to perform the disambiguation process. Step 540 identifies a group of the interactive elements with highest matching scores. For example, this can include all interactive elements which have a matching score above a threshold, or a limited number of interactive elements which have a matching score above a threshold (e.g., the top three interactive elements). In another approach, step 540 can identify a number of interactive elements which is based on a total number of interactive elements which are currently displayed on the display device (e.g., no more than one in three interactive elements). This approach ensures that the number of interactive elements involved in the disambiguation process is not excessive.

It is also possible to learn the user's interests and to adjust the score for an interactive element based on an assumed level of interest by the user in the content associated with the interactive element. For example, an interactive element associated with sports content may receive an increase in its matching score when a user profile indicates an interest in sports. This is analogous to a process for modifying results from a search engine based on a user profile.

Decision step 541 determines whether the highest matching score is greater than a first threshold (threshold1). If this decision step is evaluated to “no,” the voice command is rejected at step 551. In this case, none of the interactive elements is a good match to the voice command. If this decision step is evaluated to “yes,” decision step 542 determines if the highest matching score is greater than the next highest matching score by a second threshold (threshold2). If this decision step is evaluated to “yes,” step 552 proceeds to the click event of step 506 of FIG. 5A. In this case, the click event is generated for the one of the interactive elements in the group which is the closest match if its matching score is sufficiently high in absolute terms (e.g., above threshold1) and is sufficiently higher than a next lower matching score (e.g., based on threshold1 being sufficiently higher than threshold2). Such an interactive element is a clear match. In this case, one phrase is a best match for the voice command of the user and, in response, a click event is generated for the interactive element without a further voice command from the user.

If decision step 542 is evaluated to “no,” step 543 begins the disambiguation process. In this case, the disambiguation process is initiated if the matching score of the one of the interactive elements which is the closest match is at least one of: not sufficiently high in absolute terms, or not sufficiently higher than a next lower matching score. Step 544 modifies the display to identify the interactive elements in the group. For example, this can involve one or more of steps 545-547. Step 545 provides a unique label (optionally with a rank) on the display for each of the interactive elements in the group. See, e.g., labels 630 and 631 in FIGS. 6C and 6D. Step 546 changes an appearance on the display of the associated phrases of the interactive elements in the group. For example, see the use of a bold font for link text 610 and 612 in FIG. 6D. Step 547 removes or visually de-emphasizes (e.g., greys out) text of associated phrases of interactive elements which are not in the group. For example, see FIG. 6D in which the link text 614, additional text 615 and image 616 of an interactive element 642 are removed.

Once the labels are displayed for the interactive elements in the group, the user can be prompted to speak a subsequent voice command to select one of the labels which corresponds to the desired interactive elements. Step 548 receives the subsequent user voice command. Step 549 compares the subsequent voice command to the unique labels. Step 550 identifies one of the unique labels which is a best match to the subsequent voice command. For example, the user can select the link text of “Medicare budget talks in Congress” by speaking “one” or “first” or similar.

The process can also listen for a unique command to exit disambiguation, equivalent to a “none of these” command. Upon hearing this, the candidates are silently reject and the disambiguation process is exited.

Advantageously, the disambiguation process allows the user to select from a limited subset of the displayed elements which are most likely to be matches to what the user intended to select. A label could be provided for each displayed interactive element including those which are less likely to be matches, but this is more burdensome and less natural for the user, especially when there is a large number of elements.

FIG. 5F provides example details of step 508 of FIG. 5A for detecting and processing updated interactive element. After a document has been loaded and rendered for display, updates to the interactive elements may be received, e.g., from the server from which the document was obtained. One or more attributes of an interactive element may be changed in a dynamic update process. The changed interactive element can be re-rendered so that it is updated on the display without reloading the entire document. Advantageously, the grammar can be synchronized with such an update so that the candidate phrases in the grammar represent the updated interactive element.

Step 560 detects an update event for an interactive element. In one approach, software at the client computing device listens for an update event from a server. One example implementation uses the mutation event module of the W3C which listens for a mutation event. The mutation event module is designed to allow notification of any changes to the structure of a document, including attribute and text modifications. The update can involve a modification, addition or removal. For example, the update can comprise a new phrase which replaces an initial phrase. As an example, the link text of “Medicare budget talks in Congress” can be replaced by “Medicare budget talks now in progress.” Web page editors sometimes change the link text of an article as a story develops, for instance. To synchronize the grammar, words in the initial phrase such as “Congress” are removed and replaced by words in the new phrase such as “progress.”

In this case, step 561 re-renders the interactive element on the display. Step 562 detects the new phrase of the interactive element on the display. Step 563 replaces the initial or former phrase with the new phrase in the grammar of candidate phrases, and the new phrase is linked to the interactive element. The process is done at step 564.

FIG. 6A depicts a display of a top portion of a document in a display region of a display device. As mentioned, the rendered size of a document is often larger than the display size so that the user uses a tool such as a scroll bar 603 to scroll up or down, or left and right, to view different parts of the document. As the user scrolls, the interactive elements which are currently displayed can change. By limiting the grammar to the currently displayed interactive elements, the process of matching to the voice command can be facilitated since the user generally will not enter a voice command for interactive elements which are not currently displayed. Thus, phrases in the grammar which are derived from interactive elements which are currently displayed can be considered to be active phrases which are used for matching, and phrases in the grammar which are derived from interactive elements which are not currently displayed can be considered to be active phrases which are not used for matching. Moreover, the active and inactive phrases can be updated as the user scrolls the document in the display.

A document 600 includes a rendered top portion 602 which is currently displayed on a display device. Here, an interactive element 640 includes link text 610 and additional text 611, an interactive element 641 includes link text 612 and additional text 613, and an interactive element 642 includes link text 614 and additional text 615. In this view, the user is expected to enter a voice command which corresponds to the link text 610, 612 or 614. The link text can be for a hyperlink or other link.

The document 600 also includes a non-rendered bottom portion 604 which is not currently displayed on a display device. Here, an interactive element 643 includes link text 618, which is a hyperlink or other link, and additional text 619. An interactive element 644 includes link text 620.

Thus, the document can be rendered for the display device such that a rendered size of the document is larger than a size of the display device, thereby requiring a user to scroll to view different portions of the document. One portion (e.g., top portion 602) of the document is currently within a display region of the display device and another portion (e.g., bottom portion 604) of the document is not currently within the display region of the display device. An interactive element 640, 641 or 642 currently within the display region of the display device is in the one portion of the document and another interactive element 643 or 644 is in the another portion of the document.

FIG. 6B depicts a display of a bottom portion 660 of the document of FIG. 6A in the display region of the display device. The rendered bottom portion 660 includes the interactive element 643 with link text 618 and additional text, and the interactive element 644 with link text 620. The rendered bottom portion also includes a portion of the additional text and the image 616 of the other interactive elements 640-642. In this view, the user is expected to enter a voice command which corresponds to the link text 618 or 620.

FIG. 6C depicts the top portion of the document of FIG. 6A with disambiguation labels added to link text 610 and 612. This link text is associated with interactive elements which are in a group of interactive elements which have highest matching scores relative to a spoken phrase, consistent with step 545 of FIG. 5E. A label 630 with text of “1” is provided next to the link text 610 and a label 631 with text of “2” is provided next to the link text 612. In this view, the user is expected to enter a voice command which corresponds to the label 630 or 631. Optionally, the user can repeat the original voice command.

FIG. 6D depicts the top portion of the document of FIG. 6C with the addition of a changed appearance for the link text 610 and 612 and removal of the text and image of the interactive element 642. The link text 610 and 612 is associated with interactive elements which are in a group of interactive elements which have highest matching scores relative to a spoken phrase, consistent with step 546 of FIG. 5E. The interactive element 642 is not in the group, consistent with step 547 of FIG. 5E. The changed appearance can use a more prominent font, bolding, colors, and so forth for the link text 610 and 612. The changed appearance inform the user of the link text which is associated with the best match links and corresponding best match interactive elements.

FIG. 7A1 depicts example code of the interactive element 640 of FIG. 6A. In an example implementation, the document comprises HTML code which includes tags which define interactive elements. In this example code, an anchor tag defines a hyperlink. Between the anchor tags is the “href” attribute which specifies the Uniform Resource Locator (URL) of a linked page (“www.todaysnews.com/MedicareBudget.htm”) which is loaded when the interactive element is selected. Also between the anchor tags is the title text (“Medicare talks article”) as denoted by the keyword “title=” which specifies extra information about the interactive element. For example, the descriptive text may provide a shorthand summary of the interactive element. The title text can provide a phrase (one phrase) which is useful in matching to a voice command even if the title text is not displayed. This descriptive text typically does not appear on screen unless the user performs a specific action. This specific action can be to perform a mouse over (moving a cursor over the link text) in which case the descriptive text may appear as a tool tip.

The code further includes link text (“Medicare budget talks in Congress”) which is between the “>” and the “</a>.” This descriptive text appears on screen typically as a hyperlink with a special appearance provided by underlining and coloring.

Other tags may be used around the interactive element such as <body> and paragraph “<p>” tags, for instance (not shown). The <body> tag defines the document's body and contains all the contents of an HTML document, such as text, hyperlinks, images, tables and lists. Other tags such as a line break <br> could also be used.

FIG. 7A2 depicts an example grammar entry corresponding to FIG. 7A1. The grammar entry is linked to click event code (executable code of the element) to link to a document or other content having a specific URL. The interactive element is linked to two phrases in the grammar. The first phrase (phrase1) is “Medicare talks article.” The number of words in the phrase is Np=3. Accordingly, it is possible to construct 2-gram sub-phrases and 1-gram sub-phrases as indicated. The 2-gram sub-phrases include all 2-word combinations of the 3-word phrase, consistent with the word order. The 1-gram sub-phrases include the individual words of the 3-word phrase.

The second phrase (phrase2) is “Medicare budget talks in Congress.” The number of words in the phrase is Np=5. Accordingly, it is possible to construct 4-gram, 3-gram, 2-gram and 1-gram sub-phrases as indicated. The 4-gram sub-phrases include all 4-word combinations of the 5-word phrase, consistent with the word order. The 3-gram sub-phrases include all 3-word combinations of the 5-word phrase, consistent with the word order. The 2-gram sub-phrases include all 2-word combinations of the 5-word phrase, consistent with the word order. The 1-gram sub-phrases include the individual words of the 5-word phrase.

Generally, it is expected that the voice command will include one or more words of the phrases. However, some users may not be careful to provide a voice command which follows the exact link text in full. Also, even if the user intended to provide such a voice command, some of the words may not be accurately recognized. Moreover, some users may speak the first word, or first few words of link text while others speak certain words that they believe are most important, and others uses speak synonyms for one or more of the words. The use of sub-phrases can provide additional clues as to what the user said or intended.

For instance, referring to FIG. 6A, the user may say “The Medicare article” with an intention to select the link text 610 “Medicare budget talks in Congress.” In this case, a high matching score can be generated for the phrase “Medicare budget talks in Congress” due to the match of the word “Medicare” and for the phrase “The Medicare article” due to the match of the words “Medicare” and “article.” In one approach, an overall score for the interactive element can be based on the matching scores for each phrase which is linked to the interactive element. Variations are possible. For example, a greater weight can be given for matching to a phrase which is visible compared to a phrase which is not visible.

Note that a high matching score for the phrase associated with the interactive element 641 with the link text 612 “Are Medicare cuts inevitable” is also generated due to the match of the same word—“Medicare”. In this case, the disambiguation process may be triggered, resulting in the display of FIG. 6C or 6D. The match to “Medicare” in link text 610 may garner a higher score than the match to the same word in the link text 641 due to word order—“Medicare” is the first word in the link text 610 and the second word in the link text 612.

A low matching score for the associated interactive element with the link text 614 “Living well on a budget” due to no matching words is also generated.

No matching score is generated for the interactive elements 643 and 644 since they (e.g., their link text) are not currently displayed. For example, the voice command of “Medicare Budget” does not result in a matching score to the link text 620 “Budget Bank” even though the word “budget” is present in the link text.

FIGS. 7B1-7E2 provide example code and phrases for other interactive elements in FIGS. 6A and 6B.

FIG. 7B1 depicts example code of the interactive element 641 of FIG. 6A. Between the anchor tags is the URL address of a linked page (“www.todaysnews.com/MedicareCuts.htm”), title text (“Medicare cuts article”) and link text (“Are Medicare cuts inevitable?”).

FIG. 7B2 depicts an example grammar entry corresponding to FIG. 7B1. The grammar entry is linked to click event code which comprises a URL. The grammar includes a first phrase (“Are Medicare cuts inevitable?”) and a second phrase (“Medicare cuts article”). The n-grams can be provided as discussed in connection with FIG. 7A2.

FIG. 7C1 depicts example code of the link 614 of the interactive element 642 of FIG. 6A. Between the anchor tags is the URL address of a linked page (“www.todaysnews.com/LivingWell/51013.htm”), title text (“Living well article”) and link text (“Living well on a budget”). The additional text is also provided (“Tom Jones, pictured below, has found some surprising ways to stretch a dollar . . . ”)

FIG. 7C2 depicts example code of the image 616 of the interactive element 642 of FIG. 6A. This code can invoke the same URL as the code of FIG. 7C1. The interactive element is an image as denoted by the tag “img.” The term “src’ denotes a source path (“/images/TomJones.gif”) to an image file. The term “alt” denotes alternative text (“Tom Jones”) which is associated with the image but typically not displayed.

FIG. 7C3 depicts an example grammar entry corresponding to FIGS. 7C1 and 7C2. The grammar entry is linked to a click event code which comprises a URL. The grammar includes a first phrase (“Living well on a budget”), a second phrase (“Living well article”) and a third phrase (“Tom Jones”). In this case, the alt text of the image is linked to the URL and can be used to determine that the user desires to select this link. For example, even though the phrase “Tom Jones” is not in the link text, the user may speak this phrase after seeing the image of a person who is identified as having that name. For example, the voice command may be “Tom Jones article.” If the link text alone was relied on, there would be no match to the voice command. Use of the alt text which may not even be displayed can allow for a match to the voice command. The n-grams can be provided as discussed in connection with FIG. 7A2.

FIG. 7D1 depicts example code of the interactive element 643 of FIG. 6A. Between the anchor tags is the URL address of a linked page (“www.todaysnews.com/Weather”), title text (“Weather Home Page”) and link text (“Weather”). The additional text is also provided (“Sunny with highs in the 60's”)

FIG. 7D2 depicts an example grammar entry corresponding to FIG. 7D1. The grammar entry is linked to a click event code which comprises a URL. The grammar includes a first phrase (“Weather”) and a second phrase (“Weather Home Page”). The n-grams can be provided as discussed in connection with FIG. 7A2. Note that a voice command such as “Weather page” would have a stronger match to this interactive element using both phrases rather than just the link text due to the match to “page” in the title.

FIG. 7E1 depicts example code of the interactive element 644 of FIG. 6A. Between the anchor tags is the URL address of a linked page (“www.budgetbank.com”) and link text (“Budget Bank”). This example has no title text.

FIG. 7E2 depicts an example grammar entry corresponding to FIG. 7E1. The grammar entry is linked to click event code which comprises a URL. The grammar includes a phrase (“Budget Bank”). The n-grams can be provided as discussed in connection with FIG. 7A2.

FIGS. 7F1-7J3 provides examples of interactive elements other than links, along with their associated code and entries in a grammar.

FIG. 7F1 depicts an example of an interactive element which is a button. The button 700 includes the text of “Click Me!” The <button> tag defines a button which can include content such as text or images. When selected, such as by voice command, a specified action (click event) is triggered. For example, the voice command can be the text of the button, e.g., “Click Me!” The action can be, e.g., to display additional text or image.

FIG. 7F2 depicts example code of the interactive element of FIG. 7F1. The code is based on the button tag as follows: <button type=“button” onclick=function( )>Click Me!</button>, where “MyFunction( )” represents a JAVASCRIPT function to execute.

FIG. 7F3 depicts an example grammar entry corresponding to FIG. 7F2. The grammar entry is linked to click event code which execute the JAVASCRIPT function of “MyFunction( )” The grammar includes a first phrase (“Click Me!”) The n-grams can be provided as discussed in connection with FIG. 7A2. As mentioned, it is also possible for a phrase to be provided indicating the type of the interactive element (e.g., link, button, checkbox). In this case, the word “button” can also be added to the grammar. Thus, a voice command such as “Click button” would have a stronger match to this interactive element using the phrase “button” and “click” rather than just the phrase “click” due to the additional match to “button.”

FIG. 7G1 depicts an example of an interactive element which is an input of type submit. The displayed representation of the interactive element includes the text 710 of “Enter search term”, an input box 711 and a button 712 with the text “Search.”

FIG. 7G2 depicts example code of the interactive element of FIG. 7G1. The code indicates that an HTML form is provided. An action is to execute a file called “search.asp” using a search term which is input in the input box. This is an Active Server Page file which can contain text, HTML tags and scripts. Scripts in an ASP file are executed on a server.

FIG. 7G3 depicts example grammar entries corresponding to FIG. 7G2. The grammar entry is linked to click event code to execute the “search.asp” file using a search term (“SearchTerm”) which is input in the input box. The grammar includes a first phrase (“Enter search term”) associated with this event. The n-grams can be provided as discussed in connection with FIG. 7A2. Further, an additional grammar entry is linked to click event code which performs a search using the search term when “Search” is selected. The grammar includes a first phrase (“Search”) associated with this event. An additional phrase of “input” could be added based on the type of the interactive element.

FIG. 7H1 depicts an example of an interactive element which is an input of type checkbox. The displayed representation of the interactive element includes the text 720 of “Todays' vote: Who will win the election?”, a checkbox 721 and associated text 722 of “Gov. Jim Smith” and a checkbox 723 and associated text 724 of “Senator Luke Jones.”

FIG. 7H2 depicts example code of the interactive element of FIG. 7H1. The code indicates that a form is used with input tags of type “checkbox.” The “name” and “value” could be used as phrases which help match to a voice command. The type of “checkbox” could also be added to the grammar.

FIG. 7H3 depicts example grammar entries corresponding to FIG. 7H2. The grammar entry is linked to click event code to set a value for a checkbox (indicating it is checked) for the value of “Smith.” The grammar includes a first phrase (“Gov. Jim Smith”) associated with this event. Further, an additional grammar entry is linked to click event code to set a value for a checkbox (indicating it is checked) for the value of “Jones.” The grammar includes a first phrase (“Senator Luke Jones”) associated with this event. The n-grams can be provided as discussed in connection with FIG. 7A2.

FIG. 7I1 depicts an example of an interactive element which is an input of type radio. The displayed representation of the interactive element includes the text 730 of “Describe yourself,” a radio button 731 and associated text 732 of “Male” and a radio button 733 and associated text 734 of “Female.”

FIG. 7I2 depicts example code of the interactive element of FIG. 7I1. The code indicates that the first radio button has a name of “gender” and a value of “male.” The code also indicates that the second radio button has the name of “gender” and a value of “female.” The “name” and “value” could be used as phrases which help match to a voice command.

FIG. 7I3 depicts example grammar entries corresponding to FIG. 7I2. The first grammar entry is linked to click event code to set a value for a radio button (indicating it is selected) for the value of “male.” The grammar includes a first phrase (“Male”) associated with this event. Further, an additional grammar entry is linked to click event code to set a value for a radio button (indicating it is selected) for the value of “female.” The grammar includes a first phrase (“female”) associated with this event.

FIG. 7J1 depicts an example of an interactive element which is a select option. The displayed representation of the interactive element includes the text 740 of “Type of car” and a drop down menu in which the current selection is “Volvo.”

FIG. 7J2 depicts example code of the interactive element of FIG. 7J1. The code indicates that the first selection has a value of “CarTypeVolvo.” The “value” could be used as a phrase which helps match to a voice command. In this case, “CarTypeVolvo” can be parsed to identify the phrase “car type.” The code also indicates that the second selection has a value of “CarTypeSaab.” Additional selections could be provided as well.

FIG. 7J3 depicts example grammar entries corresponding to FIG. 7J2. The first grammar entry is linked to click event code to set a value for an option value of “CarTypeVolvo.” The grammar includes a first phrase (“Volvo”) associated with this event. Further, an additional grammar entry is linked to click event code to set a value for an option value of “CarTypeSaab.” The grammar includes a first phrase (“Saab”) associated with this event.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing a voice user interface, comprising:
analyzing a document to identify an interactive element in the document, the interactive element comprises one or more phrases;
rendering the document to provide a display on a display device, the rendering comprises determining that the interactive element is currently within a display region of the display device;
including the one or more phrases with candidate phrases responsive to the determining that the interactive element is currently within the display region of the display device;
comparing a voice command of a user to the candidate phrases; and
based on the evaluating, determining that the one or more phrases is a best match for the voice command of the user and, in response, generating a click event for the interactive element.

2. The method of claim 1, wherein:
the analyzing of the document identifies another interactive element in the document, the another interactive element comprises one or more phrases;
the rendering comprises determining that the another interactive element is not currently within the display region of the display device; and
the one or more phrases of the another interactive element are not included with the candidate phrases responsive to the determining that the another interactive element is not currently within the display region of the display device.

3. The method of claim 2, wherein:
the document is rendered for the display device such that a rendered size of the document is larger than a size of the display device, thereby requiring a user to scroll to view different portions of the document;
one portion of the document is currently within a display region of the display device;
the interactive element currently within the display region of the display device is in the one portion of the document;
another portion of the document is not currently within the display region of the display device; and
the another interactive element is in the another portion of the document.

4. The method of claim 1, wherein:
the one or more phrases comprise a title of the interactive element, the title is not displayed on the display device.

5. The method of claim 1, wherein:
the interactive element comprises a link; and
the one or more phrases comprise link text of the link.

6. The method of claim 5, wherein:
the one or more phrases comprise a title of the link, the title is not displayed on the display device.

7. The method of claim 5, wherein:
the link text is displayed on the display device.

8. The method of claim 1, wherein:
the candidate phrases are provided in a grammar which is trained using phrases of a plurality of interactive elements in the document.

9. The method of claim 1, wherein:
the interactive element comprises an image which is displayed on the display device; and
the one or more phrases comprise alternative text for the image, the alternative text is not displayed on the display device.

10. The method of claim 1, further comprising:
detecting an update event, the update event results in a change to the one or more phrases of the interactive element; and
in response to the update event, modifying the candidate phrases based on the change to the one or more phrases of the interactive element.

11. A computing device, comprising:
a display device;
a storage device which stores code and a document; and
a processor associated with the display device and the storage device, the processor executes the code to:
analyze the document to identify an interactive element in the document, the interactive element comprises one phrase which is not displayed when the document is rendered,
include the one phrase with candidate phrases;
render the document on the display device,
comparing a voice command of a user to the candidate, and
determine that the one phrase is a best match for the voice command of the user and, in response, generate a click event for the interactive element without a further voice command from the user.

12. The computing device of claim 11, wherein:
the interactive element comprises a link;
the one phrase comprises a title of the link;
the interactive element comprises another phrase which is displayed to represent the interactive element when the document is rendered; and
the another phrase comprises link text of the link.

13. The computing device of claim 11, wherein:
the interactive element comprises an image is displayed to represent the interactive element when the document is rendered; and
the one phrase comprises alternative text for the image.

14. The computing device of claim 11, wherein:
the one phrase comprises a title of the interactive element.

15. A computer-readable storage device having computer-readable software embodied thereon for use by processor in performing a method to provide a voice user interface, the method comprising:
analyzing a document to identify an interactive element in the document, the interactive element comprises an initial phrase;
rendering the document to provide a display on a display device;
including the initial phrase with candidate phrases in a grammar for a voice interface to the document;
detecting an update to the interactive element, the update comprises a new phrase which replaces the initial phrase; and
in response to the update, including the new phrase in the grammar and removing the initial phrase from the grammar.

16. The computer-readable storage device of claim 15, wherein:
the interactive element comprises a link; and
the initial phrase and the new phrase are for a title of the link, the title is not displayed when the document is rendered.

17. The computer-readable storage device of claim 15, wherein:
the interactive element comprises a link; and
the initial phrase and the new phrase are for link text of the link, the link text is displayed when the document is rendered.

18. The computer-readable storage device of claim 15, wherein:
the interactive element comprises a link to an image; and
the initial phrase and the new phrase are for alternative text for the image, the alternative text is not displayed when the document is rendered.

19. The computer-readable storage device of claim 15, wherein:
the initial phrase and the new phrase are for a title of the interactive element, the title is not displayed when the document is rendered.

20. The computer-readable storage device of claim 15, wherein:
the detecting the update to the comprises listening for an update event for the attribute.
